(19) United States
(12) Patent Application Publication
(10) Pub. No.: US 2013/0076039 A1
(43) Pub. Date: Mar. 28, 2013

(54) Wave Power Plant

(71) Applicants: Benjamin Hagemann, Gerlingen (DE); Nik Scharmann, Bietigheim-Bissingen (DE)

(72) Inventors: Benjamin Hagemann, Gerlingen (DE); Nik Scharmann, Bietigheim-Bissingen (DE)

(73) Assignee: ROBERT BOSCH GMBH, STUTTGART (DE)

(21) Appl. No.: 13/581,368

(22) PCT Filed: Feb. 2, 2011
(86) PCT No.: PCT/EP11/00476

§ 371 Date: Oct. 24, 2012

(30) Foreign Application Priority Data
Feb. 27, 2010 (DE) 10 2010 009 653.9

(51) Int. Cl. F03B 13/18

(52) U.S. Cl. CPC F03B 13/1805
USPC 290/53; 60/505; 60/496

(57) ABSTRACT

A wave power plant is configured to convert energy from a wave motion in a fluid, particularly sea water, into a rotation or rotational energy. The particles of the fluid describe a circulating orbital flow beneath the wave surface, and the kinetic energy of which is converted, at least partially, into rotational energy of one or several crankshafts. At least one resistance element and at least one buoyancy element are arranged on each crankshaft so that various coupling elements are combined.

The invention relates to a plant for converting wave energy from bodies of water. A large number of such plants are known in the prior art. These can differ according to the location of use, depending on whether they are located out at sea or near to the coast. Another distinction relates to how the energy is obtained from the wave motion. Thus, buoys or floats floating on the surface of the water are known, the rising and falling thereof being used to drive a linear generator, for example. In another plant concept, known as the “wave roller”, a blade is installed on the bottom of the sea and is tilted backward and forward by the motion of the water molecules. The kinetic energy of the blade is converted into electric power, for example, in a generator. The book entitled “Renewable Energy” by Godfrey Boyle gives an overview of wave power plants.

Common to the plants known in the prior art is the fact that they can convert only a small proportion of the energy present in a wave.

A plant concept in which the lift of a profile subject to an impinging flow is converted into rotation is furthermore shown in “A rotating wing for the generation of energy from waves” by Pinkster et al. published in 2007.

All plant concepts have the disadvantage that the speed of the rotary motion produced is often not uniform, and therefore the efficiency of the plant is suboptimal.

Given this situation, it is the underlying object of the invention to provide a wave power plant which has a higher efficiency than the plants known in the prior art.

This object is achieved by a wave power plant having the features of patent claim 1.

In the wave power plant according to the invention for converting energy of a wave motion in a fluid, a circulating orbital motion is described by particles of the fluid, the energy of which motion is converted at least partially into rotation of at least one crankshaft. In this arrangement, at least one resistance element and at least one lift element are arranged on each crankshaft. Through the combination according to the invention of these fundamentally different coupling elements on a crankshaft, irregularities in the speed of the rotary motion (e.g. a lead of the resistance element), which can occur in prior art wave energy plants, are partially compensated. It is thus possible to smooth or even out a rotary motion of the crankshaft. Moreover, the at least two coupling elements exert an increased torque on the crankshaft as compared with just one coupling element. Thus, the efficiency or energy yield of the wave power plant according to the invention is improved.

A means for converting the torque into some other form of energy is preferably provided on the at least one crankshaft.

In a particularly preferred embodiment, each crankshaft is arranged essentially horizontally and, at the same time, approximately transversely or perpendicularly to a direction of propagation of the wave and under a surface of the fluid. This optimizes the approach flow angle to the coupling elements by the orbital flow, which describes a vertical circle, for instance.

In a particularly preferred embodiment, at least one lever arm is provided between each coupling element and the associated crankshaft. This makes it possible to determine torques transmitted by the coupling elements to the crankshaft. By means of lever arms, it is furthermore possible to produce a spacing between the various coupling elements on a crankshaft, thus ensuring that the approach flows thereto do not interfere with each other. Particularly where the coupling elements are of long length, a greater stability of the wave power plant can be achieved by using a plurality of spaced lever arms.

In order to achieve a high mechanical stability of the wave power plant in a simple manner, each coupling element can be secured on the associated crankshaft by means of in each case two lever arms spaced apart along the crankshaft.

The length of the lever arms of the at least one resistance element and of the at least one lift element can be varied independently. For this purpose, hydraulic or electric motor solutions are conceivable, for example. If the length of the lever arms is adjustable during the operation of the wave power plant, two advantages are obtained, in particular: on the one hand, the circular path of the coupling elements can be adapted to different circulating orbital flows in order in this way to maximize the torque transmitted. As an alternative, adjustable lever arms can be used to move the coupling element secured thereon out of the associated circulating orbital flow in order in this way to reduce the torque transmitted by the coupling element to the crankshaft or even to brake the crankshaft. By means of selective (e.g. nonuniform) braking, the rotary motion of the crankshaft can be made even more uniform.

To produce optimum lift of the lift element, a first particularly preferred variant embodiment provides a wing profile.

The geometry of the wing profile can be variable in order to adapt it to different flow conditions of the orbital flow.

An angle of incidence between the lever arm and the lift element can be adjustable during operation in order to adapt the approach flow angle to different directions of flow of the orbital flow that occur during operation and hence to optimize the torque produced.

Here, the lever arm of the lift element can be set at about 135 degrees to the lever arm of the resistance element, and the lift element can be set at about 135 degrees to the lever arm thereof. If, for example, the lift element is a wing profile, the main plane thereof or the direction of flow around it is thus set at a maximum of 135 degrees to the lever arm thereof. In this way, an overall optimum of, on the one hand, minimized mutual interference between the two coupling elements through maximized spacing and, on the other hand, maximized torque development by the lift element about the crankshaft is provided.

Alternatively, the lever arm of the lift element can be set at about 90 degrees to the lever arm of the resistance element, the lift element being set at a maximum of 180 degrees to the lever arm thereof. This maximizes the torque developed by the lift element. Alternatively, the lever arm of the lift element can be set at about 225 degrees to the lever arm of the resistance element, the lift element being set at a maximum of 45 degrees to the lever arm thereof.

Alternatively, the lever arm of the lift element can be set at about 270 degrees to the lever arm of the resistance element, the lift element being set at a maximum of 0 degrees to the lever arm thereof. This likewise maximizes the torque developed by the lift element. The angles given are indicative values but, of course, the real values may differ from the values mentioned. The angles can be tested in practice and modified in such a way as to produce optimum lift and hence to output a maximum torque to the crankshaft.

The angle provided between the lever arms of the resistance element and of the lift element is of a highly variable character. Preferred embodiments have angles of about 90°, 135°, 180°, 225° and 270° between the lever arms.

The respective angle between the lever arm and the lift element is chosen so that a virtually optimum lift coefficient in combination with a maximum torque is obtained for the resultant approach flow to the nose base point (superimposition of the orbital flow and proper motion due to rotation about the crankshaft).

Preferably, it is also possible for the angle between the lever arms of the various coupling bodies to be varied during operation.

As an alternative, the lift element can be a surface element, which has an angle of incidence to the circulating orbital flow of the fluid.

According to one variant embodiment, the at least one resistance element can have a cylindrical shape, wherein the longitudinal axis thereof is arranged approximately parallel to the crankshaft.

In this arrangement, the radius of the resistance element can be greater than the length of the lever arm or arms.

A unilaterally supported plate, which can be flat or of concave or convex design, is conceivable as a resistance element.

In a particularly preferred development of the plant according to the invention, the resistance element has an adjustable flow resistance. This makes it possible to compensate for differences in the velocity of the orbital flow. In particular, there may be a difference in some circumstances between the lower region and the upper region of the orbital flow, and said difference can be compensated by means of this development. It is thus possible to make the rotary motion of the crankshaft even more uniform.

The flow resistance, which is dependent on an approach flow direction of the fluid, can be made more uniform in a simple manner by means of resistance elements that are not rotationally symmetrical. Said resistance elements must be secured on the lever arm in such a way that the orientation thereof in a fixed reference system is maintained at all times during a revolution of the rotor. This can preferably be accomplished by means of a gear, in which, for example, the resistance element and the crankshaft each have a gearwheel and these gearwheels intermesh via an idler gearwheel. The transmission ratios here should in each case be 1:1 in order to bring about a constant orientation. As an alternative, a belt drive is also conceivable, for example.

If the resistance element has at least one resistance body of variable volume, which can be adjusted in accordance with a rotational position of the crankshaft and of the current approach flow conditions, e.g. by allowing water in and out, the rotary motion of the crankshaft can in this way be made even more uniform.

If the damping or a phase angle of the rotary motion of the crankshaft in relation to the circulating orbital flow is adjustable or controllable, it is possible, as an alternative or supplementary measure, to compensate for differences in the velocity of the orbital flow.

To maximize torque, the damping is controlled in such a way that the phase angle between the approach flow direction and the lever arm of the resistance rotor is between 0 and 180 degrees, preferably between 75 and 105 degrees and, in particular, about 90 degrees.

In a preferred embodiment, the damping and/or the phase angle are controlled in accordance with an angle of incidence between a rotatable resistance element that is not rotationally symmetrical or the section plane thereof and the associated lever arm. Here, the resistance element that is not rotationally symmetrical assumes a “weathervane function”, where the resistance element or the section plane thereof is oriented parallel to the approach flow direction at all times.

The resistance element thus simultaneously assumes the function of a sensor, ensuring that the corresponding rotor is of simple construction. The angular position between the lever arm and the resistance element that is not rotationally symmetrical can be evaluated by means of appropriate sensors and used to control the plant.

The means for converting the torque is driven by the crankshaft and can be a hydraulic pump, in the volume flow of the pressure medium of which (e.g. hydraulic oil) the converted energy is stored. It can flow in an open or a closed circuit to a hydraulic motor, where it is converted into rotational energy. The means for converting the torque can furthermore be a mechanical gear with a generator. Desired forms of energy can include electrical energy, pressure, H₂ and desalination.

In this context, the damping and/or the phase angle can be controlled in a simple manner by means of a backpressure acting at a working port of the hydraulic pump.

Alternatively, the damping and/or the phase angle are controlled by means of a pivotable resistance surface, which outputs a braking torque to the crankshaft.

As an alternative, the damping and/or the phase angle can be controlled by means of a brake, preferably an eddy current brake.

As an alternative, the damping and/or the phase angle can be controlled by pitching and/or by changing the length of the lever arm and/or by adjusting the geometry of the wing profile and/or by changing the angle between the lever arm and the lift element and/or by changing the angle between the lever arms, since then the torque changes.

If the wave power plant has a plurality of crankshafts with corresponding coupling elements which are arranged at approximately the same depth in the fluid and are supported jointly in an approximately frame-shaped support, it is possible to multiply the output of the plant while the outlay involved in the production thereof remains relatively low.

The longer the length of the frame-shaped support and the more coupling elements are arranged in the plant, the more effectively is the plant stabilized in its position or location since the force components oriented in different directions compensate for each other. This applies to a frame which is substantially stiff in bending. In the case of plant lengths greater than two wavelengths a largely stationary position is achieved, at which the rotating coupling elements can be supported very effectively.

In order to be able to determine the position of the lever arms and hence also of the resistance elements and of the lift elements relative to the approach flow direction, sensors for determining the propagation speed and wave height and preferably for detecting local approach flow conditions are installed in the fluid and/or on the plant. These are preferably pressure sensors and/or low-torque weathervane rotors and/or pairs of piezoelectric bending transducers and/or optical sensors, having lasers for example, arranged at an angle—in particular a right angle—to one another. In this way, it is possible to control the wave energy plant in accordance with the propagation speed and phase angle of the wave.

To stabilize the frame-shaped support, a horizontal and/or vertical damping plate can be provided. As a result, significantly smaller plants, which do not extend over several wave troughs but are nevertheless positioned in a stable manner in the fluid, are also possible.

The spacings between the crankshafts can be made adjustable.

Additional advantageous developments of the invention form the subject matter of further dependent claims.

Preferred embodiments of the invention are explained in greater detail below with reference to schematic drawings, in which:

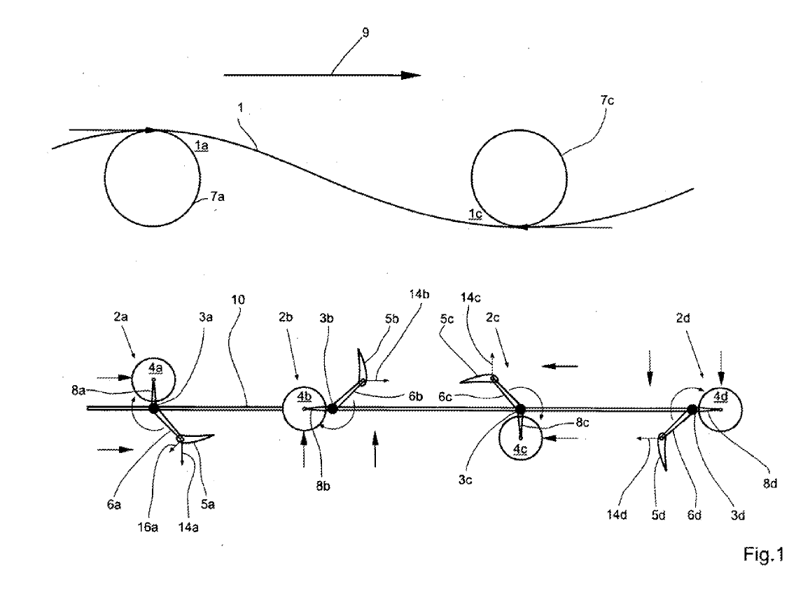

FIG. 1 shows a wave power plant in accordance with a first embodiment together with a wave (motion), in a side view;

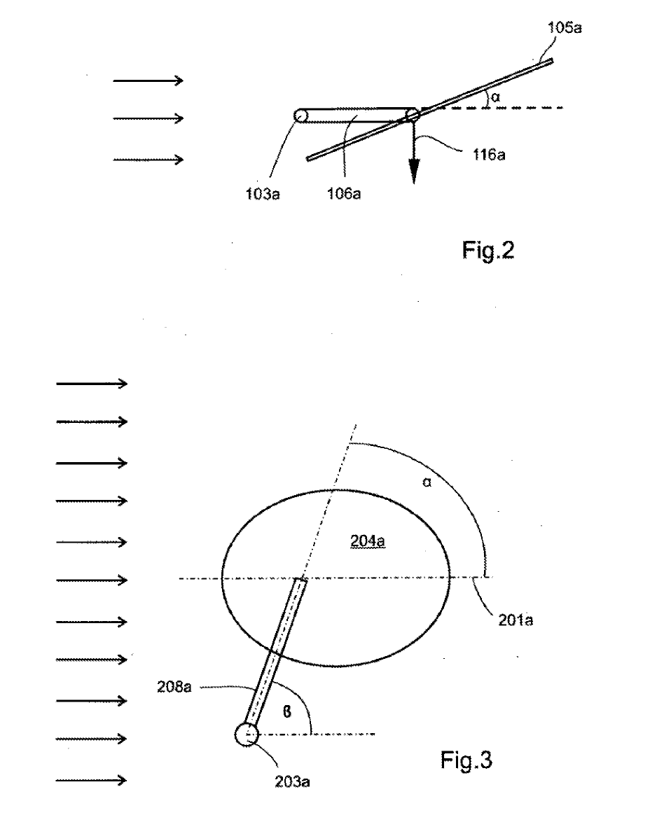

FIG. 2 shows a lift element in accordance with a second embodiment, in a schematic side view;

FIG. 3 shows a resistance element in accordance with a third embodiment, in a side view;

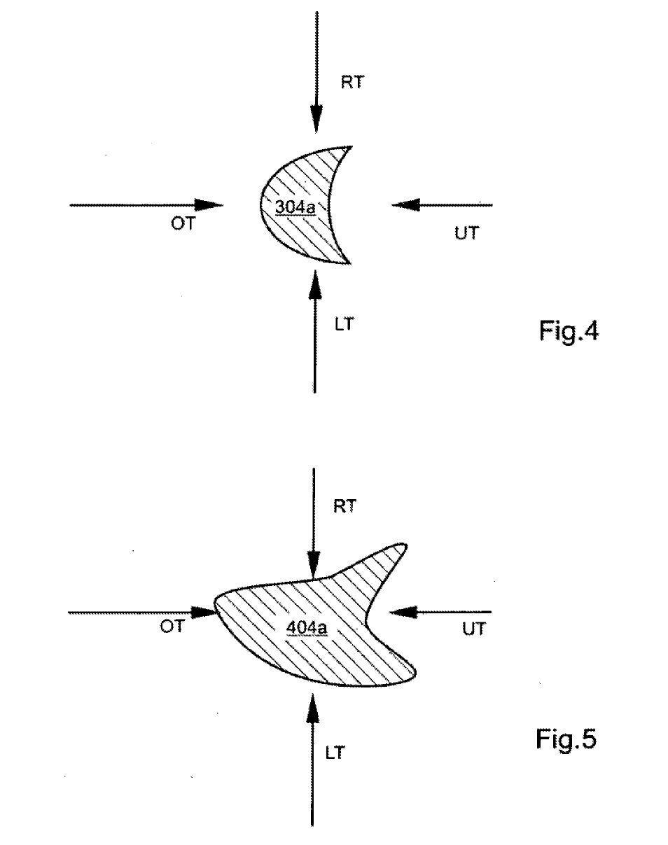

FIG. 4 shows a resistance element in accordance with a fourth embodiment, in a lateral section;

FIG. 5 shows a resistance element in accordance with a fifth embodiment, in a lateral section;

FIG. 6 shows a resistance element in accordance with a sixth embodiment in various states, in a lateral section; and

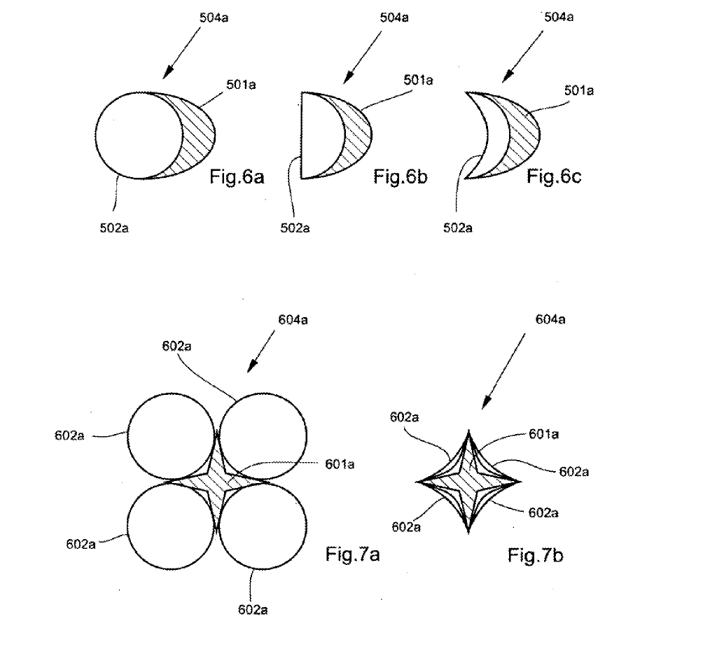

FIG. 7 shows a resistance element in accordance with a seventh embodiment in various states, in a lateral section.

FIG. 1 shows a wave power plant in accordance with a first embodiment in a simplified schematic side view.

With such a wave energy plant arranged under the water surface 1 of the sea, it is possible to make particularly efficient use of wave energy. This is based on the motion of the water molecules. Water molecules in the region of the wave move on what is termed an orbital path 7a, 7c owing to the wave motion. This will be illustrated by the following example. At a particular location, the water surface 1 is initially at a maximum (wave peak 1a), before falling, passing through the zero crossing and then reaching a minimum (wave trough 1c). The water surface 1 then rises again, once again passes through the zero crossing and reaches a maximum 1a again. The movement then begins again.

Water molecules on the water surface 1 at the wave peak 1a or under the wave peak 1a move in the direction of propagation 9 of the wave, which is assumed to be directed to the right in FIG. 1. During the subsequent zero crossover, which is shown over the rotor 2d in FIG. 1, these water molecules move downward, to the left, counter to the direction of propagation of the wave, in the wave trough 1c and, during the following zero crossover, move upward. As a result, the water molecules concerned move on circulating orbital paths, of which two orbital paths 7a and 7c are shown in FIG. 1. At the water surface 1, the diameter of these orbital paths is equal to the difference in height between the wave trough 1c and the wave peak 1a and decreases as the depth of water increases, there being almost no orbital motion at a depth of water of half the wavelength and above. The flow velocity of a circulating orbital flow is higher in the upper region than in the lower region thereof.

In shallow water, on the other hand, the water molecules no longer move on a circular path but on elliptical paths.

The first illustrative embodiment of the wave energy plant according to the invention has four rotors 2a, 2b, 2c, 2d, which each have a crankshaft 3a, 3b, 3c, 3d and, as coupling elements, a resistance element 4a, 4b, 4c, 4d and a wing profile 5a, 5b, 5c, 5d. Both coupling elements 4a, 4b, 4c, 4d, 5a, 5b, 5c, 5d are secured on the crankshaft 3a, 3b, 3c, 3d by means of two lever arms, although only one lever arm 6a, 6b, 6c, 6d, 8a, 8b, 8c, 8d is shown in each case.

In relation to the wave, the four rotors 2a, 2b, 2c, 2d are shown only diagrammatically and not necessarily to scale.

The four crankshafts 3a, 3b, 3c, 3d are supported rotatably in a frame 10. The frame 10 and the spacings between the crankshafts 3a, 3b, 3c, 3d are configured in such a way that, in the case of the torque input shown in FIG. 1, the first rotor 2a is arranged under a wave peak 1a, the third rotor 2c is arranged under a wave trough 1b and the two other rotors 2b, 2d are each arranged under transitional zones or zero crossovers of the wave 1. Owing to the circulating orbital flow 7a, 7c, the first rotor 2a is impinged upon by a flow from the left (in FIG. 1), while the second rotor 2b is impinged upon by a flow from below, the third rotor 2c is impinged upon by a flow from the right and the fourth rotor 2d is impinged upon by a flow from above.

In the embodiment shown in FIG. 1, the wavelength corresponds approximately to the spacing between the first rotor 2a and the last rotor 2d. This is advantageous since some force components compensate for each other, thus stabilizing the location of the wave energy plant. However, the wavelength may also deviate from the spacing of the rotors 2a and 2d, owing, for example, to changes in the weather. In particular, the plant may also be made significantly shorter or longer.

The operation of rotor 2a will be described below by way of example, this mode of operation also applying to the other rotors 2b, 2c, 2d. Arranged parallel to the crankshaft 3a is a resistance element 4a approximately in the form of a circular cylinder, which is secured on the crankshaft 3a at its two end face portions by respective lever arms. Only one lever arm 8a of these two lever arms is shown in FIG. 1.

Two further lever arms are arranged at about 135° to the lever arms 8a, once again only one lever arm 6a of these lever arms being shown in FIG. 1. Arranged between said lever arms 6a is a lift element, which is designed as a wing profile 5a. It is set at about 135° to the two lever arms 6a and is thus arranged approximately horizontally in FIG. 1. The angle is set in such a way, starting from the (illustrated) 135°, that an optimum approach flow to the lift element is obtained from the approach flow direction and the relative motion of the lift element.

In the case of an approach flow to the first rotor 2a from the left (in FIG. 1), the resistance element 4a is urged to the right by a resistance force, and therefore this resistance force, together with the lever arms 8a, produces a torque about the crankshaft 3a.

At the same time, the wing profile 5a is impinged upon by the flow in such a way that the lift force 14a thereof is directed substantially downward (in FIG. 1). A force component 16a of the lift force 14a, which acts perpendicularly to the lever arms 6a, together with said lever arms 6a, produces a torque about the crankshaft 3a.

Thus, each rotor 3a-d of the wave energy plant according to the invention is driven by torques or crank forces from two fundamentally different coupling elements 4a-d and 5a-d. The rotary motion of each rotor 2a-d is thus smoothed or evened out relative to prior art rotors.

To secure the wave energy plant, at least one mooring chain (not shown) is furthermore provided, said chain extending to the bottom of the sea in that end portion of the frame 10 which is on the left in FIG. 1, given the illustrated flow over the plant.

Moreover, the wave power plant according to the invention has at least one float (not shown), the buoyancy of which is adjusted or controlled in such a way that the plant has neutral buoyancy. Thus, the plant floats at a predetermined level below the water surface 1.

FIG. 2 shows a lift element of a second embodiment of the wave power plant according to the invention, in a schematic side view. Here, only a single lift element is shown by way of example, being arranged on the associated crankshaft 103a by means of a corresponding lever arm 106a. A resistance element, which is likewise secured on the crankshaft 103a, is not shown. The lift element is designed as an approximately rectangular surface element 105a, which is set at a variable or controllable angle of incidence a to the lever arms 106a.

When the arrangement according to FIG. 2 is substituted for the lever arms 6a and the wing profile 5a of the first rotor 2a in the position shown, it is accordingly impinged upon by a flow from the left (in FIG. 1 and FIG. 2). Owing to the angle of incidence a, a force component 116a perpendicular to the lever arms 106a arises, producing a torque about the crankshaft 103a together with the lever arms 106a.

FIG. 3 shows a resistance element 204a in accordance with a third embodiment of the wave energy plant according to the invention, in a side view. Unlike the resistance elements 4a-d shown in FIG. 1, the resistance element 204a shown in FIG. 3 is not rotationally symmetrical but has the shape of an elliptical cylinder. It is supported rotatably on two lever arms, of which only one lever arm 208a is shown in FIG. 3. The resistance element 204a thus has a “weathervane function”, according to which a section plane 201a of the resistance element 204a, which plane is horizontal in FIG. 3, is always aligned in the approach flow direction and hence is set at an angle of incidence a to the two lever arms 208a. During torque input by the circulating orbital flow in accordance with FIG. 3, the approach flow direction is from left to right, and the section plane 201a is aligned accordingly. The angle of incidence a is detected and used to control the damping or a lag of the crankshaft 203a. The damping gives rise to a phase angle β, at which the lever arms 208a are set relative to the approach flow direction. In the swung-in state (shown in FIG. 3), a is equal to β.

In principle, the phase angle β can be between 0 and 180 degrees. The damping of the crankshaft 203a is preferably adjusted or controlled in such a way that 75°<β<105°. A phase angle β of 90 degrees is the optimum since the torque output to the crankshaft 203a by the resistance element 204a is optimized.

FIG. 4 shows a resistance element 304a in accordance with a fourth embodiment of the wave energy plant according to the invention, in a lateral section. In the case of this resistance element 304a, the resistance force (for the production of a corresponding torque) is dependent on the approach flow direction. To this end, the resistance element 304a is not rotationally symmetrical in design and is connected to the lever arms (not shown) in such a way that the differently shaped surfaces take effect with different approach flow directions during one revolution of the resistance element 304a about the crankshaft (not shown).

The side on the right (in FIG. 4), which is impinged upon by the flow of fluid in accordance with the arrow UT in the bottom dead center position of the resistance element 304a, is of concave design and offers the highest resistance in comparison with the approach flow directions in the other dead center positions RT, LT, OT. The left-hand side of the resistance element 304a (in FIG. 4) is of convex design and offers minimal resistance in an approach flow direction in the top dead center position OT, in comparison with the other approach flow directions RT, LT, UT. Through symmetry about the axis, the top and bottom sides offer an equal flow resistance, which is between the two abovementioned levels of flow resistance.

With the resistance element 304a shown in FIG. 4, the fundamental differences in the velocity of a circulating orbital flow 7a, 7c can be compensated. The water molecules of a circulating orbital flow move faster in the region of the top dead center position OT than in the region of the bottom dead center position UT. In the intermediate right-hand and left-hand dead center positions RT, LT, the flow velocity is also intermediate. The shaping of the resistance element 304a compensates for these differences and ensures uniform torque transmission to the crankshaft (not shown).

FIG. 5 shows a resistance element 404a in accordance with a fifth embodiment, in a lateral section. Here, said resistance element 404a represents a development of the resistance element 304a in FIG. 4. The shaping of the resistance element 404a additionally serves to compensate for differences in the velocity of the flow in the left-hand dead center position LT and the flow in the right-hand dead center position RT. Here, the cross section of the resistance element 404a is designed for the case where the velocity of the flow in the left-hand dead center position LT is higher than that in the right-hand dead center position RT. For compensation, that side of the resistance element 404a which is at the top (in FIG. 5) is of partially concave design, while the lower side of the resistance element 404a is of convex design. The flow resistance of the resistance element 404a in the right-hand dead center position of the revolution (cf. resistance element 4d in FIG. 1) is thus higher than that in the left-hand dead center position of the revolution (cf. resistance element 4b in FIG. 1).

FIGS. 6a to 6c show a resistance element 504a in accordance with a sixth embodiment of the wave energy plant according to the invention in three different states, in each case in a lateral section. The resistance element 504a has a fixed main body 501a with a convex outer side arranged on the right (in FIGS. 6a to 6c). Moreover, the main body 501a has a concave inner side (in FIGS. 6a to 6c), on which an inflatable resistance body 502a formed by a rubber tube is mounted.

FIG. 6a shows the tube 502a in a state in which it is filled with seawater, while FIG. 6c shows the tube 502a in a largely empty state. FIG. 6b shows the tube 502a in a state in which it is partially filled with seawater. By virtue of the different degrees of filling shown, the resistance element 504a has a convex surface (cf. FIG. 6a) or an approximately flat surface (cf. FIG. 6b) or a concave surface (cf. FIG. 6c) on the side which is on the left (in FIGS. 6a-c). Moreover, states between the states shown are also possible. In this way, the flow resistance of the side on the left (in FIGS. 6a-c) can be adapted approximately to that on the right-hand side or increased or reduced relative thereto. With the resistance element 504a in accordance with the sixth embodiment, it is thus possible to output different torques to the crankshaft (not shown), especially if the degree of filling of the tube 502a is controlled in accordance with the position of revolution of the resistance element 504a.

FIGS. 7a and 7b show a resistance element 604a in accordance with a seventh embodiment in two different states, in a lateral section. The resistance element 604a has a rigid main body 601a, on which four uniformly distributed recesses are arranged. Arranged in each recess is a rubber tube 602a, FIG. 7a showing the four tubes 602a in a state in which they are completely filled with seawater, while FIG. 7b shows the four tubes 602a in a largely empty state. Here too, infinitely variable intermediate states between the two states shown are possible.

The resistance element 604a in accordance with the seventh embodiment allows modification of the flow resistance over a comparatively wide range, making it possible for greatly varying torques to be output to the crankshaft (not shown) by the resistance element 604a, depending on the degree of filling of the four tubes 602a. The four tubes 602a do not have to be filled uniformly, as shown, but can also be filled independently of one another.

The damping of the rotors 2a-d and of the crankshafts 3a-d; 103a; 203a of all the embodiments of the present invention can be accomplished by means of a controllable brake, in particular an eddy current brake. If the wave power plant according to the invention drives one or more hydraulic motors, the damping of the crankshafts 3a-d; 103a; 203a can also be accomplished by means of a variable backpressure, which is adjusted or controlled at an outlet port of the hydraulic motor or motors.

The damping of the crankshafts 3a-d; 103a; 203a can also be accomplished by means of a drive train variant incorporating a mechanical gear and a generator. By means of this drive train variant, the energy of the crankshafts 3a-d; 103a; 203a is converted into electrical energy.

Also suitable for damping is a pivotable or rotatable resistance surface (not shown), which produces a braking resistance by means of the water. Control of such dampers can be performed in accordance with a propagation speed and a phase position of the wave. These can be determined by means of pressure sensors or by means of additional torque-free weathervane rotors, for example. These always align themselves parallel to the approach flow direction, thereby determining the latter. The relative positions of the weathervane rotors can be evaluated with the aid of acceleration sensors. As an alternative, the instantaneous approach flow direction of the water or of the circulating orbital flow 7a, 7c can also be determined by means of two piezoelectric bending transducers arranged at an angle, in particular a right angle, to one another. As a departure from this, the phase angle β can also be controlled by varying the respective angle of incidence a of the resistance element 204a; 304a; 404a; 504a that is not rotationally symmetrical, and/or of the lift element 5a-d; 105a. By varying this angle of incidence a, it is possible to adjust the resistance force or lift force of the corresponding coupling element 5a-d, 105a; 204a; 304a; 404a; 504a and thus control the output torque thereof.

As an alternative or supplementary measure, it is also possible for the length of the corresponding lever arms 6a-d, 8a-d; 106a; 208a to be of adjustable design. By this means too, the torque output by the corresponding coupling element 4a-d, 5a-d; 105a; 204a; 304a; 404a; 504a; 604a, which is rotationally symmetrical or not rotationally symmetrical, can be adjusted or controlled.

Maximization of the torque output by the lift elements or wing profiles is accomplished by pitching or by changing the angles of incidence of the lift elements.

As a departure from the first embodiment, which is shown in FIG. 1, the lever arms 6a-d of the wing profiles 5a-d can also be arranged or set at only 90 degrees to the lever arms 8a-d of the resistance elements 4a-d. Accordingly, the angle of incidence of the wing profiles 5a-d is increased to a value of about 180 degrees in order to obtain the correct approach flow. During operation, this is adjusted in such a way that an optimum approach flow to the lift element 5a-d is obtained. In this embodiment (not shown in greater detail), the spacing of the wing profiles 5a-d from the resistance element 4a-e is reduced, and this can lead to a slight impairment of the approach flow to the wing profiles 5a-e. However, this disadvantage could be overcompensated by more effective exploitation of the lift force 14a-e of the wing profiles 5a-e. Instead of the reduced force component 16a, which amounts to about 70% of the lift force 14a (cf. FIG. 1), the entire lift force 14a is used to produce torque in this embodiment (not shown in greater detail).

As a departure from the second embodiment, which is shown in FIG. 2, both lever arms 106a can have the position of lever arm 6a of the first rotor 2a in accordance with FIG. 1. The angle of incidence a of the surface element 105a relative to the lever arm 106a is accordingly increased by about 45 degrees. As a result, the spacing of the surface element 105a from the associated resistance element 4a is increased, which can lead to an improvement in the approach flow to the surface element 105a. Here too, however, as in the embodiment described in FIG. 1, various angles between the lever arms of the resistance element and those of the surface element 105a are possible. An optimum angle of incidence a to the approach flow direction can be set, thus optimizing the torque.

The frame, in particular that in accordance with the first preferred embodiment of the invention, can have a length of significantly more than 100 m. The decisive factor here is to match the length of the frame to the wave frequency that can be expected in such a way that it preferably spans two wavelengths. This makes it possible to ensure that the forces acting directly thereon balance out and therefore that the wave energy plant rests in a relatively steady manner in the water. However, the problem here is the internal stability of the plant, which must withstand even extreme weather conditions, such as storms. Therefore, the maximum length of the plant is limited.

The fact that the water molecules close to the water surface move more vigorously than those at greater depths of water is exploited by the invention in two different ways:

On the one hand, the frame is held at depths close to the water surface in order to apply as high external forces as possible to the coupling elements and thus increase the economic efficiency of the plant. On the other hand, it is possible to use a so-called damping plate to stabilize the frame, said damping plate being arranged at greater depths of water and being connected to the frame by a coupling device.

In a flow of water, the damping plate produces a flow resistance which is as high as possible. This damper plate is oriented horizontally and/or vertically in the water and thus forms a force application surface for the water. The coupling device is preferably rigid and is formed, for example, by vertically extending columns which are fixed at the ends to the frame and to the damper plate in order to be able to transmit tensile and compression forces. The damper plate connected to the frame in this way, which is arranged in very deep water thus counteracts any movement of the frame with a damping action and holds the frame in position. It is thus possible to reduce the length of the frame.

A disclosure is made of a wave energy plant for converting energy from a wave motion in a fluid, in particular seawater, into rotation or rotational energy. Under the surface of the waves, the particles of the fluid describe a circulating orbital flow, the kinetic energy of which is converted at least partially into rotational energy of one or more crankshafts. In this arrangement, at least one resistance element and at least one lift element, i.e. coupling elements of different kinds, are combined on each crankshaft.

### LIST OF REFERENCE SIGNS

1 water surface
1a wave peak
1c wave trough
2a, 2b, 2c, 2d rotor
3a, 3b, 3c, 3d crankshaft
4a, 4b, 4c, 4d resistance element
5a, 5b, 5c, 5d wing profile
6a, 6b, 6c, 6d lever arm
7a, 7c orbital path
8a, 8b, 8c, 8d lever arm
9 direction of propagation
10 frame
14a, 14b, 14c, 14d lift force
16a force component
103a crankshaft
105a surface element
106a lever arm
116a force component
201a section plane
203a crankshaft
204a resistance element
208a lever arm
304a resistance element
404a resistance element
501a main body
502a resistance body
504a resistance element
601a main body
602a resistance body
604a resistance element
a angle of incidence
β phase angle
OT flow in the top dead center position
UT flow in the bottom dead center position
LT flow in the left-hand dead center position
RT flow in the right-hand dead center position

1. A wave power plant configured to convert energy from a wave motion in a fluid, in which a circulating orbital motion is described by particles of the fluid, comprising:
a plurality of coupling elements configured to convert at least partially the energy of the wave motion into rotation of at least one crankshaft,
wherein at least two coupling elements of the plurality of coupling elements are arranged on the at least one crankshaft, of which coupling elements at least one coupling element is a resistance element and at least one coupling element is a lift element.

2. The wave power plant as claimed in claim 1, wherein:
the at least one crankshaft is rotated with a torque, and
the at least one crankshaft includes a means for converting the torque into some other form of energy.

3. The wave power plant as claimed in claim 1, wherein the at least one crankshaft is arranged essentially horizontally and approximately transversely to a direction of propagation of the wave and under a surface of the fluid.

4. The wave power plant as claimed in claim 1, further comprising:
at least one lever arm positioned between each coupling element of the plurality of coupling elements and the at least one crankshaft.

5. The wave power plant as claimed in claim 4, wherein in each case at least one resistance element and at least one lift element are secured on the crankshaft by means of in each case two lever arms spaced apart along the crankshaft.

6. The wave power plant as claimed in claim 4, wherein a length of the lever arms is adjustable during the operation of the wave power plant.

7. The wave power plant as claimed in claim 1, wherein a lift element is a wing profile.

8. The wave power plant as claimed in claim 7, wherein a geometry of the wing profile is adjustable.

9. The wave power plant as claimed in claim 4, wherein an angle of incidence between the lever arm and the lift element is adjustable during operation.

10. The wave power plant as claimed in claim 4, wherein:
the lever arm of the lift element is set at about 135 degrees to the lever arm of the resistance element, or
the lever arm of the lift element is set at about 90 degrees or at about 180 degrees or at about 225 degrees or at about 270 degrees to the lever arm of the resistance element.

11. The wave energy plant as claimed in claim 4, wherein an angle between lever arms is adjustable during the operation of the wave power plant.

12. The wave power plant as claimed in claim 1, wherein a lift element is a surface element, which has an angle of incidence to the circulating orbital flow of the fluid.

13. The wave power plant as claimed in claim 1, wherein:
a resistance element has the shape of a circular cylinder or an elliptical cylinder, and
a longitudinal axis thereof is arranged approximately parallel to the crankshaft.

14. The wave power plant as claimed in, claim 4, wherein a radius of the resistance element is greater than a length of the lever arm.

15. The wave power plant as claimed in claim 1, further comprising:
a surface-forming resistance element,
wherein one surface is flat or convexly or concavely curved.

16. The wave power plant as claimed in claim 1, wherein the resistance element has an adjustable flow resistance.

17. The wave power plant as claimed in claim 4, wherein the resistance element is not rotationally symmetrical and is secured on the lever arm in such a way that the orientation thereof in a fixed reference coordinate system is maintained at all times.

18. The wave power plant as claimed in claim 17, wherein the resistance element is coupled to the crankshaft by a gear or a belt drive.

19. The wave power plant as claimed in claim 16, wherein the resistance element has at least one resistance body of variable volume, which can be adjusted in accordance with a rotational position of the crankshaft and by allowing water in and out.

20. The wave power plant as claimed in claim 1, wherein a damping or a phase angle between the at least one lever arm of the resistance element and the circulating orbital flow is adjustable or controllable.

21. The wave power plant as claimed in claim 20, wherein the damping is controlled in such a way that the phase angle is about 90 degrees.

22. The wave power plant as claimed in claim 20, wherein an angle of incidence between a rotatable resistance element that is not rotationally symmetrical and the associated lever arm can be detected, in accordance with which angle the damping and/or the phase angle can be controlled.

23. The wave power plant as claimed in claim 2, wherein:
the means for converting the torque is a hydraulic pump or a gear with an electric generator, and
the means for converting the torque can be driven by the crankshaft.

24. The wave power plant as claimed in claim 23, wherein the damping and/or the phase angle is controlled by means of a backpressure acting at a working port of the hydraulic pump and/or by a torque at the generator.

25. The wave power plant as claimed in claim 20, wherein the damping and/or the phase angle is controlled by means of a pivotable or rotatable resistance surface or by means of an eddy current brake.

26. The wave power plant as claimed in claim 20, wherein the damping and/or the phase angle is controlled by pitching and/or by changing the length of the lever arm and/or by adjusting the geometry of the wing profile and/or by changing the angle between the lever arm and the lift element and/or by changing the angle between the lever arms.

27. The wave power plant as claimed in claim 1, further comprising:
a plurality of crankshafts, which are arranged at approximately the same depth in the fluid and are supported jointly in an approximately frame-shaped support.

28. The wave power plant as claimed in claim 27, wherein the support extends over a plurality of wave peaks and/or over a plurality of wave troughs (1c).

29. The wave power plant as claimed in claim 1, wherein pressure sensors and/or low-torque weathervane rotors and/or pairs of piezoelectric bending transducers or optical sensors, having a laser, arranged at an angle to one another are provided in the fluid.

30. The wave power plant as claimed in claim 27, wherein the support includes a horizontal and/or vertical damping plate.
